(19) United States
(12) Patent Application Publication
(10) Pub. No.: US 2006/0181731 A1
(43) Pub. Date: Aug. 17, 2006

(54) Image retrieving apparatus, an image retrieving method, and a recording medium

(75) Inventors: Shuichi Ohtsuka, Kanagawa (JP); Makoto Hara, Kanagawa (JP); Yutaka Ueda, Tokyo (JP); Po-Chieh Hung, Tokyo (JP); Timothy J. Whitcher, New York, NY (US); Thiagarajah Arujunan, New York, NY (US)

Correspondence Address: BIRCH STEWART KOLASCH & BIRCH, PO BOX 747, FALLS CHURCH, VA, 22040-0747, US

(73) Assignees: Fuji Photo Film Co., Ltd., Minami-Ashigara-Shi (JP); KONICA MINOLTA PHOTO IMAGING, INC., Tokyo (JP); EASTMAN KODAK COMPANY, Rochester, NY (US)

(21) Appl. No.: 11/059,681

(22) Filed: Feb. 17, 2005

(51) Int. Cl. G06F 3/12

(52) U.S. Cl. 358/1.15

(57) ABSTRACT

An image retrieving apparatus for retrieving a plurality of original images from a recording medium on which a plurality of original images taken are recorded, includes an index retrieving unit for retrieving an index manifest file from the recording medium; an asset manifest retrieving unit for retrieving an asset manifest file from the recording medium by using a path, stored in the retrieved index manifest file, to the asset manifest file; and an image retrieving unit for retrieving at least a part of the plurality of original images from the recording medium by using a path, stored in the retrieved asset manifest file, to each of the plurality of original images, wherein the recording medium includes the plurality of original images; the asset manifest file storing the path to each of the plurality of original images; and the index manifest file storing the path to the asset manifest file, and the index manifest file is stored on a predetermined path which is not different for each recording medium.

The present application attaches hereto Appendices A-1, A-2 and A-3, the contents of which are incorporated herein by reference.

### BACKGROUND OF THE INVENTION

1. Field of the Invention

The present invention relates to an image retrieving apparatus, an image retrieving method, and a recording medium. More particularly, the present invention relates to an image retrieving apparatus and an image retrieving method for retrieving a plurality of original images from a recording medium on which a plurality of original images taken are recorded and the recording medium.

2. Description of the Related Art

Conventionally, an image retrieving apparatus for retrieving original image(s) taken which are recorded on a recording medium from the recording medium has been known. Here, for example, Fujicolor® CD determined by the applicant of the present application is known as a format of the recording medium.

However, a region of the above recording medium, on which the original image(s) are recorded, that is, a path to each of the original image(s) is varied according to the format of the recording medium. Thus, in case a user intends to use an image retrieving apparatus, there has been a problem that the user cannot use the image retrieving apparatus if the retrieving apparatus does not correspond to the format of a recording medium owned by the user.

### SUMMARY OF THE INVENTION

Therefore, it is an object of the present invention to provide an image retrieving apparatus, an image retrieving method, and a recording medium, which are capable of overcoming the above drawbacks accompanying the conventional art. The above and other objects can be achieved by combinations described in the independent claims. The dependent claims define further advantageous and exemplary combinations of the present invention.

According to the first aspect of the present invention, an image retrieving apparatus for retrieving a plurality of original images from a recording medium on which a plurality of original images taken are recorded, includes an index retrieving unit for retrieving an index manifest file from the recording medium; an asset manifest retrieving unit for retrieving an asset manifest file from the recording medium by using a path, stored in the retrieved index manifest file, to the asset manifest file; and an image retrieving unit for retrieving at least a part of the plurality of original images from the recording medium by using a path, stored in the retrieved asset manifest file, to each of the plurality of original images, wherein the recording medium includes the plurality of original images; the asset manifest file storing the path to each of the plurality of original images; and the index manifest file storing the path to the asset manifest file, and the index manifest file is stored on a predetermined path which is not different for each recording medium.

The recording medium may further include a plurality of display images generated by decreasing resolution of the plurality of original images, the asset manifest file may further store a path to each of the plurality of display images, the image retrieving unit may retrieve at least a part of the plurality of display images from the recording medium by using the path, stored in the retrieved asset manifest file, to each of the plurality of display images, and the image retrieving apparatus may further include an image display unit for displaying a retrieved display image.

The recording medium may further include the album manifest file which determines a displaying order of at least a part of the plurality of the original images, the index manifest file may further store the path to the album manifest file, the image retrieving unit may retrieve the display image in case the path to the display image generated from the original image is stored in the asset manifest file, or the original image in case the path to the display image generated from the original image is not stored in the asset manifest file, for each of the original images which should be displayed according to the displaying order determined by the retrieved album manifest file, the image display unit displays the display image or the original image, and the image retrieving apparatus may further include an album manifest retrieving unit for retrieving an album manifest file from the recording medium by using a path, stored in the retrieved index manifest file, to the album manifest file.

According to the second aspect of the present invention, an image retrieving method for retrieving a plurality of original images from a recording medium on which a plurality of original images taken are recorded, includes an index retrieving step of retrieving an index manifest file from the recording medium; an asset manifest retrieving step of retrieving an asset manifest file from the recording medium by using a path, stored in the retrieved index manifest file, to the asset manifest file; and an image retrieving step of retrieving at least a part of the plurality of original images from the recording medium by using a path, stored in the retrieved asset manifest file, to each of the plurality of original images, wherein the recording medium includes the plurality of original images; the asset manifest file storing the path to each of the plurality of original images; and the index manifest file storing the path to the asset manifest file, and the index manifest file is stored on a predetermined path which is not different for each recording medium.

The recording medium may further include a plurality of display images generated by decreasing resolution of the plurality of original images, the asset manifest file may further store a path to each of the plurality of display images, and during the image retrieving step, at least a part of the plurality of display images is retrieved from the recording medium by using the path, stored in the retrieved asset manifest file, to each of the plurality of display images. The image retrieving method may further include an image display step of displaying a retrieved display image.

The recording medium may further include the album manifest file which determines a displaying order of at least a part of the plurality of the original images, the index manifest file may further store the path to the album manifest file, and during the image retrieving step, the display image is retrieved in case the path to the display image generated from the original image is stored in the asset manifest file, or the original image is retrieved in case the path to the display image generated from the original image is not stored in the asset manifest file, for each of the original images which should be displayed according to the displaying order determined by the retrieved album manifest file. During the image display step, the display image or the original image may be displayed. The image retrieving method may further include an album manifest retrieving step of retrieving an album manifest file from the recording medium by using a path, stored in the retrieved index manifest file, to the album manifest file.

According to the third aspect of the present invention, a recording medium on which a plurality of original images taken are recorded, includes a plurality of original images; an asset manifest file storing a path to each of the plurality of original images; and an index manifest file storing a path to the asset manifest file, wherein the index manifest file is stored on a predetermined path which is not different for each recording medium.

The recording medium may further include a plurality of display images generated by decreasing resolution of the plurality of original images, wherein the asset manifest file may further store a path to each of the plurality of display images.

The recording medium may further include an album manifest file which determines a displaying order of at least a part of the plurality of original images, wherein the index manifest file may further store the path to the album manifest file.

The summary of the invention does not necessarily describe all necessary features of the present invention. The present invention may also be a sub-combination of the features described above. The above and other features and advantages of the present invention will become more apparent from the following description of the embodiments taken in conjunction with the accompanying drawings.

### BRIEF DESCRIPTION OF THE DRAWINGS

FIG. 1 shows an example of the configuration of an image using system 10 which is an example of an image using system according to an embodiment of the present invention.

FIG. 2 shows an example of a directory construction and a file construction of a recording medium 30 according to an embodiment of the present invention.

FIG. 3 is a block diagram showing an example of a function configuration of an image recording apparatus 20 according to an embodiment of the present invention.

FIG. 4 is a block diagram showing an example of a function configuration of an image retrieving apparatus 40 according to an embodiment of the present invention.

FIG. 5 is a flowchart showing an example of a flow of process by an image recording method using the image recording apparatus 20 according to an embodiment of the present invention.

FIG. 6 is a flowchart showing an example of a flow of process by an image retrieving method using the image retrieving apparatus 40 according to an embodiment of the present invention.

FIG. 7 is a flowchart showing another example of a flow of process by an image recording method using the image recording apparatus 20 according to an embodiment of the present invention.

FIG. 8 shows an example of the configuration of an image using system 50 which is another example of the image using system according to an embodiment of the present invention.

FIG. 9 is a flowchart showing an example of a flow of process by an image recording method using an image recording apparatus 70 according to an embodiment of the present invention.

### DETAILED DESCRIPTION OF THE INVENTION

The invention will now be described based on the preferred embodiments, which do not intend to limit the scope of the present invention, but exemplify the invention. All of the features and the combinations thereof described in the embodiment are not necessarily essential to the invention.

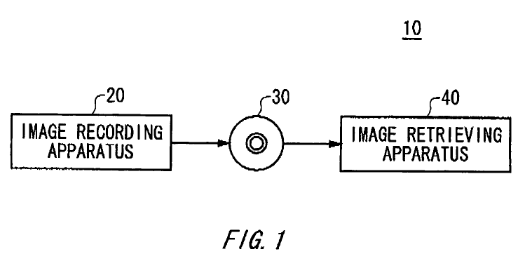

FIG. 1 shows an example of the configuration of an image using system 10 which is an example of an image using system according to an embodiment of the present invention. The image using system 10 according to the present embodiment records an original image taken on a recording medium 30, or retrieves the original image recorded on the recording medium 30 and displays or prints the retrieved original image. It is an object of the image using system 10 according to the present embodiment to correctly retrieve a plurality of original images regardless of which region of the recording medium 30 the plurality of original images are recorded on. Further, in case of recording a new original image on the recording medium on which the original images are previously recorded, it is another object of the image using system 10 according to the present embodiment to prevent the original images previously recorded from being removed without intention. Furthermore, in case of adding a new original image on the recording medium 30 on which the plurality of original images and a manifest showing a slideshow based on the plurality of original images are previously recorded, it is another object of the image using system 10 according to the present embodiment to enhance using efficiency of capacity of the recording medium 30.

The image using system 10 according to the present embodiment includes an image recording apparatus 20, a recording medium 30, and an image retrieving apparatus 40. The image recording apparatus 20 records a plurality of original images, for example, taken by a digital camera, on the recording medium 30. Here, the original image may be a still picture or a moving picture. Further, the image recording apparatus 20 may be an image taking apparatus such as a digital camera or an information processing apparatus such as a personal computer. The image retrieving apparatus 40 retrieves the plurality of original images taken from the recording medium 30 on which the plurality of original images are recorded. Then, the image retrieving apparatus 40 provides a user with the retrieved original images by displaying or printing them. The image retrieving apparatus 40 may be a video reproducing apparatus such as a DVD-Video player, an information processing apparatus such as a personal computer, or a kiosk terminal provided in a DPE service shop.

According to the present figure, the image recording apparatus 20 and the image retrieving apparatus 40 may be provided separately from each other or one of them may have the function and configuration of the other. Further, each of the image recording apparatus 20 and the image retrieving apparatus 40 may include a plurality of apparatus different from each other and the plurality of apparatus may perform a function of the recording apparatus 20 or the image retrieving apparatus 40 by communicating with each other.

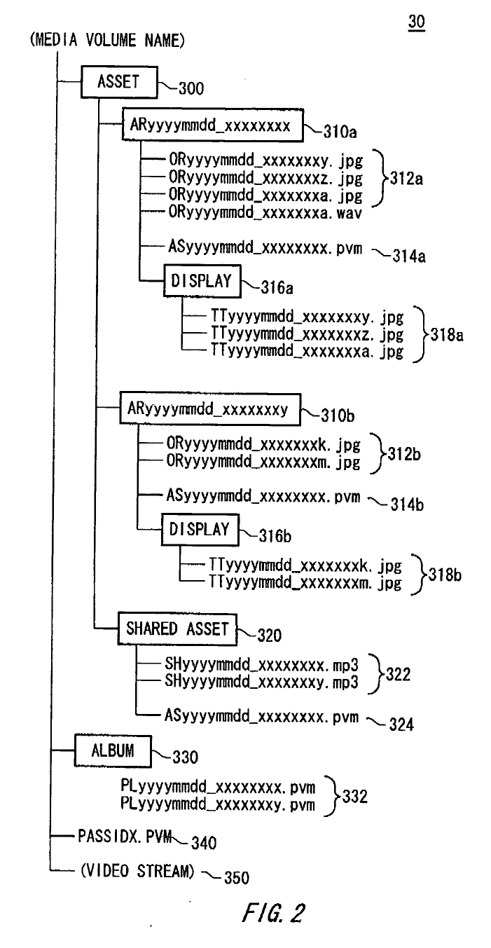

FIG. 2 shows an example of a directory construction and a file construction of the recording medium 30 according to the present embodiment. The recording medium 30 according to the present embodiment stores an asset directory 300, an album directory 330, an index manifest file 340, and a video stream 350 right under a root directory.

The asset directory 300 stores data used by the image using system 10 such as an original image taken, a voice, and a piece of music via a plurality of asset roll directory (310a and 310b; hereinafter, referred to 310) and a shared directory 320. Further, the asset directory 300 stores two roll asset roll directories 310 in the present figure but may have one roll asset roll directory or more than three roll asset roll directories.

The asset roll directory 310a stores a plurality of original images 312a, an asset manifest file 314a, and a display image directory 316a. Further, the asset roll directory 310a may further store a recorded voice. The plurality of original images 312a may be a still picture and a moving picture, for example, taken by a digital camera. The asset manifest file 314a stores a path to each of the plurality of original images 312a which are stored in the asset roll directory 310a. The display image directory 316a is placed in a lower level of the asset roll directory 310a and stores a plurality of display images 318a. The plurality of display images 318a are images which are displayed instead of the plurality of original images 312 and may be images generated by, for example, decreasing resolution of the plurality of original images. Further, the asset roll directory 310a may store a plurality of display image directories which are different in resolution, an aspect ratio, etc. of the display image. Thus, even in case each display apparatus and method for displaying the display image has different resolution and aspect ratio, it is possible to display images of good display quality which are suitable to the display apparatus and method. Further, the asset manifest file 314a stores further a path to each of the plurality of display images 318a.

The asset roll directory 310b stores a plurality of original images 312b, an asset manifest file 314b, and a display image directory 316b. As shown in the present embodiment, a plurality of original images can be stored dividedly in a plurality of asset roll directories of the recording medium 30.

The shared director 320 stores a plurality of shared files 322 and a shared manifest file 324. The shared file may be a piece of music performed as a BGM in case at least a part of the original image 312 and the display image 318, which are stored in the asset roll directory 310, are displayed as a slideshow. The shared manifest file 324 stores a path to each of the plurality of shared files 322.

The album directory 330 stores a plurality of album manifest files 332. Each of the plurality of album manifest files 332 determines a displaying order of at least a part of the plurality of original images recorded on the recording medium 30 (312a and 312b; hereinafter, referred to 312). Specifically, the album manifest file 332 stores a path to the asset manifest files (314a, 314b; hereinafter, referred to 314) storing the path to each of the original images which should be displayed and an image identifier for identifying each of the images which should be displayed according to the displaying order. Further, in this case, the asset manifest file 314 may store the path to each of the plurality of original images and the image identifier for identifying the original image, correspondently.

The index manifest file 340 stores the path to each of the plurality of asset manifest files 314 and the path to each of the plurality of album manifest files 332. Further, the index manifest file 340 is not varied according to the recording medium 30 and is recorded on a predetermined path. Specifically, the index manifest file 340 may be recorded as a name of “PASSIDX.PVM” right under the root directory of the recording medium 30.

The video stream 350 may be a group of files or directories including a video stream of, for example, a DVD-Video format. Further, the video stream 350 may be a video stream showing a slideshow based on the displaying order determined by the album manifest file 332. Thus, it is possible for even a display device which cannot retrieve the album manifest file 332 and the display image 318 to display a slideshow to display the slideshow by reproducing the recording medium 30 as a DVD-Video disk.

Further, at least a part of the asset directory 300, the asset roll directory 310, the plurality of original images 312, the asset manifest file 314, the display image directories (316a and 316b; hereinafter, referred to 316), the plurality of display images 318, the shared director 320, the plurality of shared files 322, the shared manifest files 324, the album directory 330, and the plurality of album manifest files 332 shown in the present figure may be varied according to the format of the recording medium 30 predetermined by, for example, the user. Here, the format of the recording medium 30 may be, for example, Fujicolor® CD, Picture CD®, and HotAlbum®.

The asset roll directory 310 may have a directory name distinguishing each of the asset roll directories 310 of each of a plurality of recording mediums 30. Similarly, at least apart of the plurality of original images 312, the asset manifest file 314, the display image directory 316, the plurality of display images 318, the shared directory 320, the plurality of shared files 322, the shared manifest file 324, the album directory 330, and the plurality of album manifest files 332 may also have a name distinguishing each of the files and the directories of each of a plurality of recording mediums 30.

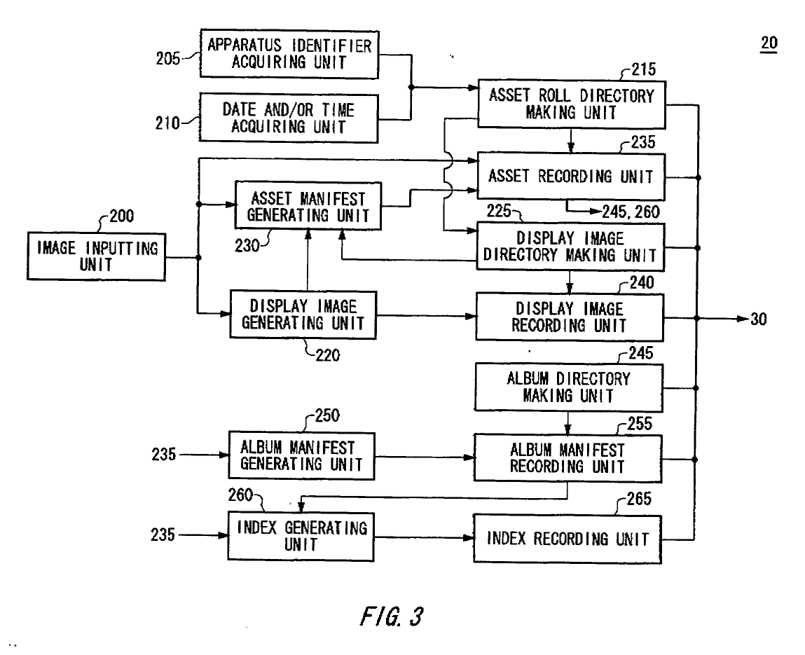

FIG. 3 is a block diagram showing an example of a function configuration of the image recording apparatus 20 according to the present embodiment. The image recording apparatus 20 includes an image inputting unit 200, an apparatus identifier acquiring unit 205, a date and/or time acquiring unit 210, an asset roll directory making unit 215, a display image generating unit 220, a display image directory making unit 225, an asset manifest generating unit 230, an asset recording unit 235, a display image recording unit 240, an album directory making unit 245, an album manifest generating unit 250, an album manifest recording unit 255, an index generating unit 260, and an index recording unit 265.

The image inputting unit 200 inputs the plurality of original images taken. For example, the image inputting unit 200 may input the plurality of original images 312 by performing data communication with the digital camera which takes the plurality of original images 312 or by retrieving the plurality of original images 312 from another recording medium and memory apparatus on which the plurality of original images 312 are recorded. Then, the image inputting unit 200 outputs the plurality of original images which are input to the display image generating unit 220, the asset manifest generating unit 230, and the asset recording unit 235.

The apparatus identifier acquiring unit 205 acquires an identifier which can identify the image recording apparatus 20. Here, the apparatus identifier may be, for example, a MAC (Media Access Control) address allocated to a network interface of the image recording apparatus 20. Further, the apparatus identifier acquiring unit 205 outputs the acquired apparatus identifier to the asset roll directory making unit 215. The date and/or time acquiring unit 210 acquires the present time by using a clock function and a calendar function of the image recording apparatus 20. The date and/or time acquiring unit 210 outputs the acquired present time to the asset roll directory making unit 215.

The asset roll directory making unit 215 makes the asset roll directory 310 storing the plurality of original images input by the image inputting unit 200 in the recording medium 30. Here, the asset roll directory making unit 215 may make the asset roll directory 310 to have a directory name distinguishing each of the asset roll directories 310 of each of a plurality of recording mediums. Specifically, the asset roll directory making unit 215 may determine a directory name different for each apparatus identifier on the basis of the apparatus identifier received from the apparatus identifier acquiring unit 205. Further, on the basis of the date and/or time at which the asset roll directory 310 is generated received from the date and/or time acquiring unit 210, the asset roll directory making unit 215 may determine the directory name different for each date and/or time. Further, the asset directory 300 storing the asset roll directory 310 is determined for the asset roll directory making unit 215 according to the predetermined format of the recording medium 30. In case the asset directory does not exist in the recording medium 30, it is possible to make the asset roll directory 310 after making the asset directory 300. Then, the asset roll directory making unit 215 outputs a path to the asset roll directory 310 which is made for the recording medium 30 to the display image directory making unit 225 and the asset recording unit 235.

The display image generating unit 220 generates the plurality of display images 318 by decreasing the resolution of the plurality of original images 312 input by the image inputting unit 200. Here, for each of the plurality of display images 318, the display image generating unit 220 may generate a file name of the display image 318 by transforming the file name of the original image 312 used when the display image 318 is generated by a predetermined rule which is inverse-transformable. Specifically, for each of the plurality of display images 318, the display image generating unit 220 may generate the file name of the display image 318 by changing a leading character string of a predetermined length of the file name of the original image 312 used when the display image 318 is generated to a different character string. Here, the file name of each of the original images 312 may be a file name determined by the image inputting unit 200 while the original image 312 is input. Then, the display image generating unit 220 outputs the plurality of display images 318 to the display image recording unit 240. Further, the display image generating unit 220 outputs the file name of each of the plurality of the display images 318 to the asset manifest generating unit 230.

The display image directory making unit 225 makes the display image directory 316 storing the plurality of display image 318 generated by the display image generating unit 220 in a lower level of the asset roll directory 310 made by the asset roll directory making unit 215. Then, the display image directory making unit 225 outputs a path to the display image directory 316 to the display image recording unit 240. Further, the display image directory making unit 225 outputs the path to the display image directory 316 and the path to the asset roll directory 310 to the asset manifest generating unit 230.

The asset manifest generating unit 230 generates the asset manifest file 314 storing the path to each of the plurality of original images 312 in case the plurality of original images 312 input by the image inputting unit 200 are recorded on the recording medium 30 and the path to each of the plurality of display images 318 in case the plurality of display images 318 generated by the display image generating unit 220 are recorded on the recording medium 30. Here, the asset manifest generating unit 230 may detect the path to each of the plurality of original images 312 and the path to each of the plurality of display images 318 on the basis of a predetermined positional relationship between the asset manifest file 314 and the asset roll directory 310, for example, that the asset manifest file 314 is stored right under the asset roll directory 310. Then, the asset manifest generating unit 230 may detect the path to each of the plurality of original images 312 on the basis of the file name of each of the plurality of original images 312 input from the image inputting unit 200 and a predetermined positional relationship between the plurality of original images 312 and the asset roll directory 310, for example, that the plurality of original images 312 is stored right under the asset roll directory 310. Further, the asset manifest generating unit 230 may detect the path to each of the plurality of display images 318 on the basis of the file name of each of the plurality of display images 318 received from the display image generating unit 220, the path to the display image directory 316 and the path to the asset roll directory 310 received from the display image directory making unit 225. Then, the asset manifest generating unit 230 outputs the generated asset manifest file 314 to the asset recording unit 235.

The asset recording unit 235 records the plurality of original images 312 received from the image inputting unit 200 and the plurality of asset manifest file 314 received from the asset manifest generating unit 230 on the recording medium 30 so as to be recorded in the asset roll directory 310 made by the asset roll directory making unit 215. Then, the asset recording unit 235 outputs the path to the recorded asset manifest file 314 and the image identifier for identifying each of the plurality of original images 312 recorded to the album generating manifest generating unit 250. Further, the asset recording unit 235 outputs the path to the recorded asset manifest file 314 to the index generating unit 260. The display image recording unit 240 records the plurality of display images 318 generated by the display image generating unit 220 on the recording medium so as to be recorded in the display image directory 316 made by the display image directory making unit 225.

The album directory making unit 245 makes the album directory 330 storing the album manifest file 332 in a position which is not a lower level of the asset roll directory 310 made by the asset roll directory making unit 215. For example, the album directory making unit 245 may make the album directory 330 to be stored in the root directory of the recording medium 30. Then, the album directory making unit 245 outputs a path to the made album directory 330 to the album manifest recording unit 255.

The album manifest generating unit 250 generates the album manifest file 332 storing the path to the asset manifest file 314 recorded on the recording medium 30 and a displaying order in case the plurality of original images 312 recorded on the recording medium 30 are displayed. Specifically, the album manifest generating unit 250 may store the image identifier for identifying the original image 312 in the album manifest file 332 correspondingly to the displaying order. Then, the album manifest generating unit 250 outputs the generated album manifest file 332 to the album manifest recording unit 255. The album manifest recording unit 255 records the album manifest file 332 generated by the album manifest generating unit 250 on the recording medium 30 to be stored in the album directory 330 made by the album directory making unit 245. Then, the album manifest recording unit 255 outputs the path to the recorded album manifest file 332 to the index generating unit 260.

The index generating unit 260 generates the index manifest file 340 storing the path to the asset manifest file 314 recorded on the recoding medium 30 by the asset recording unit 235 and the path to the album manifest file 332 recorded on the recording medium 30 by the album manifest recording unit 255. Then, the index generating unit 260 outputs the generated index manifest file 340 to the index recording unit 265. The index recording unit 265 records the index manifest file 340 generated by the index generating unit 260 on a predetermined path which is not varied according to the recording medium 30.

According to the image recording apparatus 20 of the present embodiment, it is possible to set the directory name different for each of the plurality of recording mediums to the directory name of the asset roll directory 310. Thus, in case of copying the asset roll directory 310 recorded on the recording medium 30 to another recording medium and memory apparatus, it is possible to prevent the asset roll directory 310 previously stored in said another recording medium and memory apparatus from being overwrote. Accordingly, it is possible to prevent a file stored in said another recording medium and memory apparatus from being removed without intention.

Further, it is possible to exactly prevent the directory name of the asset roll directory 310 from being duplicated for a recording medium 30 recorded by different image recording apparatus 20 by determining the name of the directory name of the asset roll directory 310 on the basis of the apparatus identifier such as the MAC address. Further, it is possible to exactly prevent the directory name of the asset roll directory 310 from being duplicated for a plurality of recording mediums 30 recorded by the same image recording apparatus 20 by determining the directory name of the asset roll directory 310 on the basis of the date and/or time at which the asset roll directory 310 is made.

Further, the asset roll directory 310 is copied to another recording medium by making the display image directory 316 in a lower level of the asset roll directory 310. Thus, it is possible to copy the original image 312 stored in the asset roll directory 310 and the display image 318 generated from the original image 312 collectively. Thus, it becomes easy to manage image data recorded on the recording medium 30.

Further, by transforming the file name of the original image by a rule which is inverse-transformable to generate the file name of the display image 318, it is possible to detect a corresponding relationship between the original image 312 and the display image 318 even in case the asset manifest file 314 is lost, for example. In addition, it is possible detect a corresponding relationship between the original image 312 and the display image 318 with a simple configuration and a short time by changing the leading character string of the file name of the original image 312 to another character string to generate the file name of the display image 312.

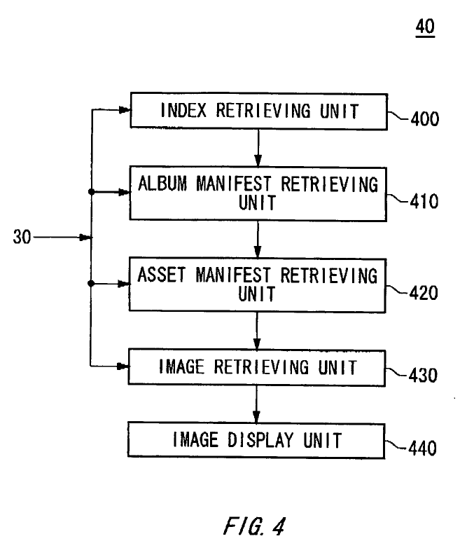

FIG. 4 is a block diagram showing an example of a function configuration of the image retrieving apparatus 40 according to the present embodiment. The image retrieving apparatus 40 of the present embodiment includes an index retrieving unit 400, an album manifest retrieving unit 410, an asset manifest retrieving unit 420, an image retrieving unit 430, and an image display unit 440. The image retrieving apparatus 40 of the present example displays a slideshow based on the plurality of original images 312 recorded on the recording medium 30 according to the album manifest file 332 recorded on the recording medium 30.

The index retrieving unit 400 retrieves the index manifest file 340 from the recording medium 30. Here, the index retrieving unit 400 is not varied according the recording medium 30 and may retrieve the index manifest file 340 by using a predetermined path. Then, the index retrieving unit 400 outputs the retrieved index manifest file 340 to the album manifest retrieving unit 410. The album manifest retrieving unit 410 retrieves the album manifest file 332 from the recording medium 30 by using the path to the album manifest file 332 which is stored in the index manifest file 340 retrieved by the index retrieving unit 400. Then, the album manifest retrieving unit 410 outputs the retrieved album manifest file 332 to the asset manifest retrieving unit 420. The asset manifest retrieving unit 420 retrieves the asset manifest file 314 from the recording medium 30 by using the path to the asset manifest file 314 which is stored in the album manifest file 332 retrieved by the album manifest retrieving unit 410. Then, the asset manifest retrieving unit 420 outputs the retrieved asset manifest file 314 to the image retrieving unit 430.

The image retrieving unit 430 retrieves at least a part of the plurality of original images 312 from the recording medium 30 by using the path to each of the plurality of original images 312 which is stored in the asset manifest file 314 retrieved by the asset manifest retrieving unit 420. Further, the image retrieving unit 430 may retrieve at least a part of the plurality of display images 318 from the recording medium 30 by using the path to each of the plurality of display images 318 which is stored in the asset manifest file 314, instead of retrieving the original image 312. Specifically, the image retrieving unit 430 retrieves the display image 318 in case the path to the display image generated from the original image is stored in the asset manifest file sequentially or retrieves the original image 312 in case the path to the display image 318 generated from the original image 312 is not stored in the asset manifest file, for each of the original images 312 which should be displayed according to the displaying order determined by the album manifest file 332 retrieved by the album manifest retrieving unit 410. Then, the image display unit 440 displays the original image 312 or the display image 318 retrieved by the image retrieving unit 430.

According to the image retrieving apparatus 40 of the present embodiment, since the path to the index manifest file 340 in which the path to the asset manifest file 314 is stored is determined regardless of the format of the recording medium, it is possible to accurately retrieve the asset manifest file 314 even in case the path to the asset manifest file 314 is varied according to the format of the recording medium. Thus, it is possible to accurately retrieve each of the plurality of original images 312 on the basis of the retrieved asset manifest file 314 even in case a region on which the plurality of original images 312 are recorded, that is, the path to each of the original images is different for each recording medium.

Further, in case the resolution of the image display unit 440 is lower than that of the original image 312, a large part of the information of the original image 312 is not displayed and the time taken to retrieve the data and memory are wasted. However, according to the image retrieving apparatus 40 of the present embodiment, since the display image 318 of which resolution is lower that that of the original image 312 is previously recorded on the recording medium 30, it is possible to perform image retrieval and display efficiently and at high speed by retrieving and displaying the display image 318 corresponding to the original image 312 instead of the original image 312. Further, since the path to the display image 318 is stored in the asset manifest file 314, it is possible to accurately retrieve the display image 318 even in case the path to the display image 318 is varied according to the format of the recording medium 30.

Further, since the path to the album manifest file 332 is stored in the index manifest file 340, it is possible to accurately retrieve the original image 312 and the display image 318 even in case the path to the album manifest file 332 is varied according to the format of the recording medium 30.

Furthermore, the image retrieving apparatus 40 may display the original image 312 or the display image 318 regardless of the album manifest file 332. In this case, the image retrieving apparatus 40 may not include the album manifest retrieving unit 410 and the asset manifest retrieving unit 420 may retrieve the asset manifest file 314 by using the path to the asset manifest file 314 stored in the index manifest file 340 instead of the album manifest file 332.

In addition, the image retrieving apparatus 40 may not include the image display unit 440. In this case, the image retrieving apparatus 40 may provide the user with the original image 312 by, for example, printing the original image 312 retrieved by the image retrieving unit 430. Further, the image retrieving apparatus 40 may output the original image 312 or the display image 318 retrieved by the image retrieving unit 430 to a display apparatus of the outside and display the image by the display apparatus, for example.

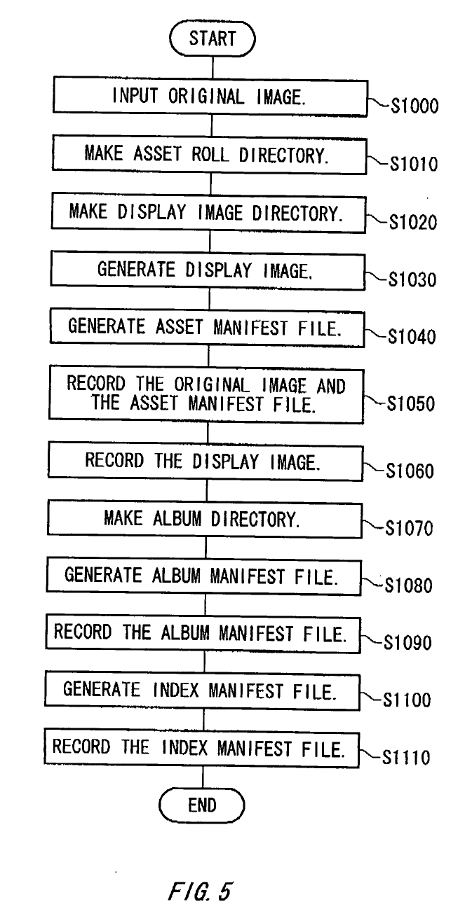

FIG. 5 is a flowchart showing an example of a flow of process by an image recording method using the image recording apparatus 20 according to the present embodiment. The image inputting unit 200 inputs the plurality of original images taken 312 (S1000). The asset roll directory making unit 215 makes the asset roll directory 310 in which the plurality of original images input 312 are stored in the recording medium 30 as a directory name for distinguishing the asset roll directory 310 of each of a plurality of recording mediums (S1010). The display image directory making unit 225 makes the display image directory 316 in which the plurality of display images 318 are stored in a lower level of the made asset roll directory 310 (S1020). The display image generating unit 220 generates the plurality of display images 318 by decreasing resolution of the plurality of original images input 312 (S1030).

Then, the asset manifest generating unit 230 generates the asset manifest file 314 which stores the path to each of the plurality of original images 312 in case the plurality of original images input 312 are recorded on the recording medium 30 and the path to each of the plurality of original images 312 in case the plurality of display images generated 318 are recorded on the recording medium 30 (S1040). The asset recording unit 235 records the plurality of original images input 312 and the generated asset manifest file 314 on the recording medium so as to be stored in the made asset roll directory 310 (S1050). The display image recording unit 240 records the plurality of display image generated 318 on the recording medium 30 so as to be stored in the made display image directory 316 (S1060).

Then, the album directory making unit 245 makes the album directory 330 in which the album manifest file 332 is stored in a position which is not a lower level of the made asset roll directory 310 (S1070). The album manifest generating unit 250 generates the album manifest file 332 which stores the path to the asset manifest file 314 recorded on the recording medium 30 and the displaying order of the plurality of original images 312 recorded on the recording medium 30 (S1080). The album manifest recording unit 255 records the generated album manifest file 332 on the recording medium 30 so as to be stored in the made album directory 330 (S1090).

Then, the index generating unit 260 generates the index manifest file 340 which stores the path to the asset manifest file 314 recorded on the recording medium 30 and the path to the album manifest file 332 recorded on the recording medium 30 (S1100). The index recording unit 265 records the generated index manifest file 340 on a predetermined path which is not different foe each recording medium 30 (S1110).

According to the image recording apparatus 20 of the present embodiment, it is possible to make the album directory 330 in a position which is not a lower level of the asset roll directory 310. Thus, in case of using the album manifest file 332 determining a displaying order of images over a plurality of asset roll directories 310, it is not necessary to move the album manifest file 332 even if the asset roll directory 310 is deleted from the recording medium 30.

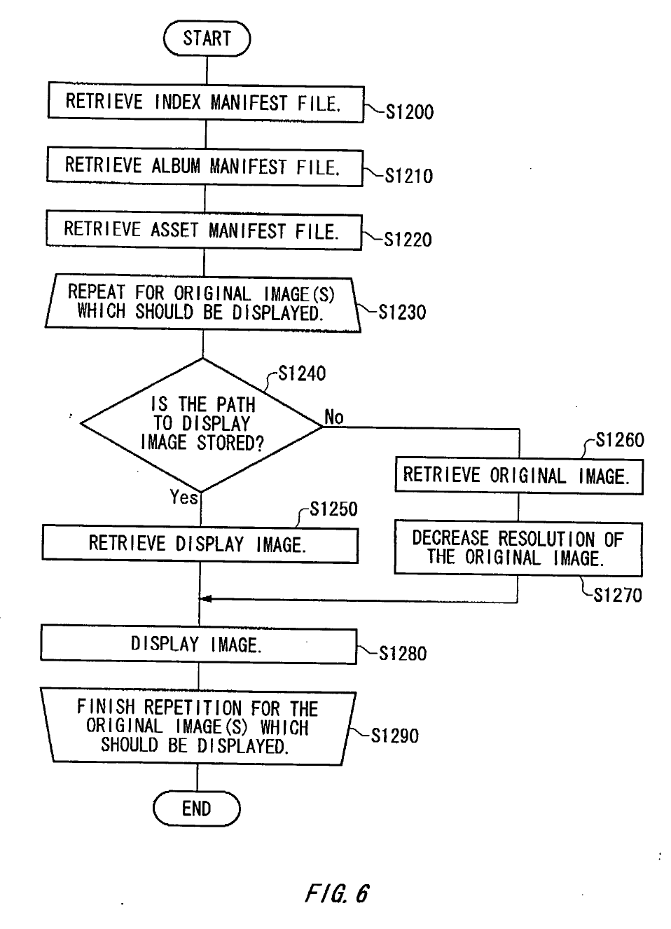

FIG. 6 is a flowchart showing an example of a flow of process by an image retrieving method using the image retrieving apparatus 40 according to the present embodiment. The index retrieving unit 400 retrieves the index manifest file 340 from the recording medium 30 (S1200). The album manifest retrieving unit 410 retrieves the album manifest file 332 from the recording medium 30 by using the path to the album manifest file 332 stored in the retrieved index manifest file 340 (S1210). The asset manifest retrieving unit 420 retrieves the asset manifest file 314 from the recording medium 30 by using the path to the asset manifest file 314 stored in the retrieved album manifest file 332 (S1220).

Then, the image retrieving apparatus 40 repeats the following processes for the original image(s) 312 which are determined to be displayed by the album manifest file 332 (S1230). The image retrieving unit 430 determines whether or not the path to the display image 318 generated from the original image 312 is stored in the asset manifest file 314 (S1240). For example, the image retrieving unit 430 determines whether or not the path to the display image 318 corresponding to the image identifier for identifying the original image 312 is stored in the asset manifest file 314. In case the path to the display image 318 is stored in the asset manifest file 314 (S1240: Yes), the image retrieving unit 430 retrieves the display image 318 by using the path to the display image 318 (S1250).

On the other hand, in case the path to the display image 318 is not stored in the asset manifest file 314 (S1240: No), the image retrieving unit 430 retrieves the original image 312 by using the path to the original image 318 stored in the asset manifest file 314 (S1260). Then, the image retrieving unit 430 decreases the resolution of the retrieved original image 312 according to the resolution of the image display unit 440 (S1270).

Then, the image display unit 440 displays the retrieved display image 318 or the original image 312 which is retrieved and of which resolution is decreased (S1280). Here, in case the user instructs to print the displayed image by using an input means provided in the image retrieving apparatus 40, the image retrieving apparatus 40 may retrieve the original image 312 from the recording medium 30 and outputs it to a printing means of the image retrieving apparatus 40 or a printing apparatus of the outside. Then, the image retrieving apparatus 40 repeats the above processes for all images which should be displayed (S1290).

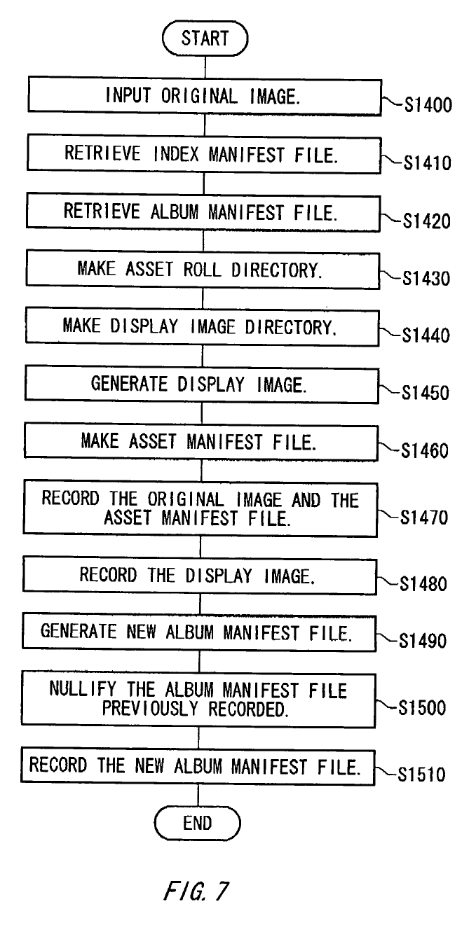

FIG. 7 is a flowchart showing another example of the flow of process by the image recording method using the image recording apparatus 20 according to the present embodiment. In the present example, the image recording apparatus 20 records a plurality of new original images 312 and a new album manifest file 332 on the recording medium 30 on which the plurality of original images 312 and the album manifest file 332 are previously recorded. Further, in the present example, the recording medium 30 is a write-once type recording medium a region of which information can be recorded on only one time and information can be recoded on a region of the write-once type recording medium on which information is not recorded yet. Further, the image recording apparatus 20 of the present example includes the image retrieving apparatus 40 shown in FIG. 4 and can retrieve in formation such as a manifest recorded on the recording medium 30.

The image inputting unit 200 inputs a plurality of new original images 312 (S1400). The index retrieving unit 400 retrieves the index manifest file 340 previously recorded from the recording medium 30 (S1410). The album manifest retrieving unit 410 retrieves the album manifest file 332 previously recorded from the recording medium 30 by using the path to the album manifest file 332 stored in the retrieved index manifest file 340 (S1420) The asset roll directory making unit 215 makes a new asset roll directory 310 storing the plurality of new original images input 312 in the recording medium 30 to have a directory name distinguishing each of the asset roll directories 310 of each of a plurality of recording mediums (S1430). The display image directory making unit 225 makes a new display image directory storing a plurality of display images in a lower level of the made new asset roll directory 310 (S1440). The display image generating unit 220 generates the plurality of new display images 318 by decreasing resolution of the plurality of original images input 312 (S1450).

The asset manifest generating unit 230 generates a new asset manifest file 314 which stores a path to each of the plurality of new original images 312 in case the plurality of new original images input 312 are recorded on the recording medium 30 and a path to each of the plurality of new display images 318 in case the plurality of new display images generated 318 are recorded on the recording medium 30. The asset recording unit 235 records the plurality of new original images 312 and the new asset manifest file generated 314 on a region of the recording medium on which information is not recorded yet so as to be stored in the new asset roll directory made 310 (S1470). The display image recording unit 240 records the plurality of new display images generated 318 on a region of the recording medium on which information is not recorded yet so as to be stored in the new display image directory made 316 (S1480).

The album manifest generating unit 250 generates a new album manifest file 332 by storing further a path to the new asset manifest file made 314 and a displaying order in case the plurality of new original images input 312 are displayed in the album manifest file 332 previously recorded on the recording medium 30 (S1490). The album manifest recording unit 255 nullifies the album manifest file 332 recorded on the recording medium 30 (S1500). The album manifest recording unit 255 records the new album manifest file generated 332 on a region of the recording medium on which information is not recorded yet (S1510). For example, the album manifest recording unit 255 may record the new album manifest file 332 on the recording medium 30 with the same path as the album manifest file 332 previously recorded. Further, the album manifest recording unit 255 may record file management information that a physical region of the recording medium corresponding to the path to the album manifest file 332 is changed from a physical region of the album manifest file 332 previously recorded to a physical region of the new album manifest file 332, on the recording medium 30.

In case the new original image 312 is additionally recorded on the write-once type recording medium on which the original image 312 is previously recorded, if a slideshow is recorded as a video stream, it is needed to generate the video stream once again and record it. Since a data amount of a video stream is large than that of a still picture generally, the generated video stream cannot be recorded on the recording medium on which a video stream is already recorded and thus sometimes it should be recorded on a new recording medium. However, according to the image recording apparatus 20 of the present embodiment, it is possible to make the recording medium for displaying a slideshow to which the new original image 312 is added by only recording the new original image 312 and simultaneously renewing the new album manifest file 332. Thus, it is possible to use the recording area of the recording medium 30 efficiently. Further, since the process of recording the plurality of original images 312 and renewing the album manifest file 332 can be performed in a short time in comparison with a process of generating and recording a video stream, it is possible to improve convenience of the user in case of adding a plurality of new original images by using the image recording apparatus 20 of the present embodiment.

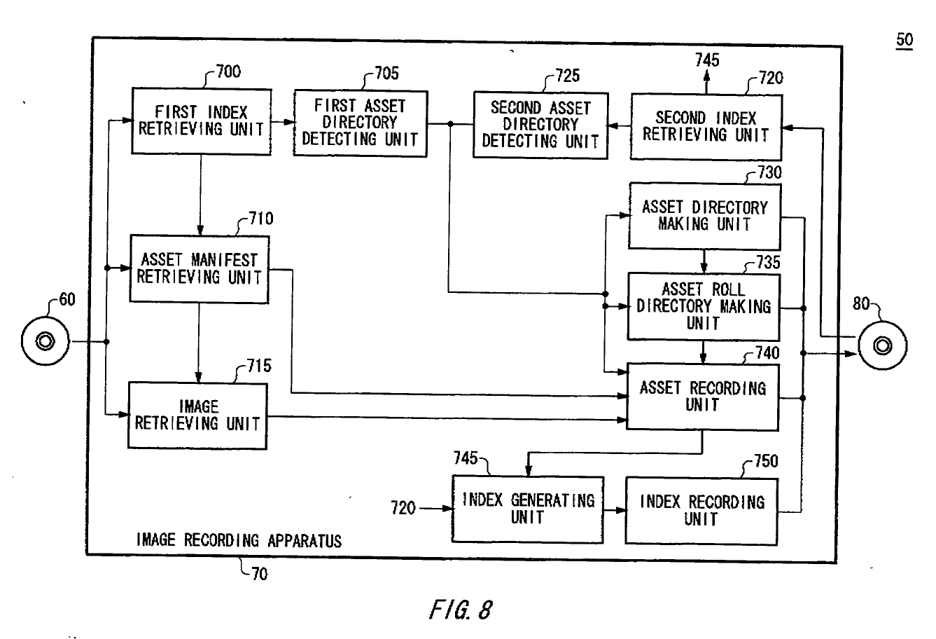

FIG. 8 shows an example of the configuration of an image using system 50 which is another example of the image using system according to the present embodiment of the present invention. The image using system 50 of the present embodiment records a plurality of original images 312 recorded on a first recording medium 60 on a second recording medium 80. The image using system 50 of the present embodiment includes the first recording medium 60, an image recording apparatus 70, and the second recording medium 80. Further, the each of the first and second recording medium 60 and 80 may include a directory construction and a file construction which are substantially the same as those of the recording medium 30 shown in FIG. 2.

The recording apparatus 70 of the present embodiment includes a first index retrieving unit 700, a first asset directory detecting unit 705, an asset manifest retrieving unit 710, an image retrieving unit 715, a second index retrieving unit 720, a second asset directory detecting unit 725, an asset directory making unit 730, an asset roll directory making unit 735, an asset recording unit 740, an index generating unit 745, and an index recording unit 750.

The first index retrieving unit 700 retrieves the index manifest file 340 from the first recording medium 60. Here, the first index retrieving unit 700 is not different for each first recording medium 60 and may retrieve the index manifest file 340 by using a predetermined path. Then, the first index retrieving unit 700 outputs the retrieved index manifest file 340 to the first asset directory detecting unit 705 and the asset manifest retrieving unit 710.

The first asset directory detecting unit 705 detects a directory name of the asset directory 300 including the asset roll directory 310 stored in the first recording medium 60 on the basis of a path to the asset manifest file 314 stored in the index manifest file 340 retrieved by the first index retrieving unit 700. Here, the first asset directory detecting unit 705 may detect that the asset directory 300 does not exist in case the first recording medium 60 does not include the asset roll directory 300 and includes the asset roll directory 310 right under the root directory. The first asset directory detecting unit 705 outputs the path to the asset manifest file 314 of the first recording medium 60 and the detected directory name of the asset directory 300 to the asset directory making unit 730, the asset roll directory making unit 735, and the asset recording unit 740.

The asset manifest retrieving unit 710 retrieves the asset manifest file 314 from the first recording medium 60 by using the path to the asset manifest file 314 stored in the index manifest file 340 retrieved by the first index retrieving unit 700. Then, the asset manifest retrieving unit 710 outputs the retrieved asset manifest file 314 to the image retrieving unit 715 and the asset recording unit 740. The image retrieving unit 715 retrieves the plurality of original images 312 from the first recording medium 60 by using a path to each of the plurality of original images 312 stored in the asset manifest file 314 retrieved by the asset manifest retrieving unit 710. Then, the image retrieving unit 715 outputs the plurality of original images retrieved 312 to the asset recording unit 740.

The second index retrieving unit 720 retrieves the index manifest file 340 from the second recording medium 80. Here, the second index retrieving unit 720 is not different for each second recording medium 80 and may retrieve the index manifest file 340 by using a predetermined path. Then, the second index retrieving unit 720 outputs the retrieved index manifest file 340 to the second asset directory detecting unit 725 and the index generating unit 745.

The second asset directory detecting unit 725 detects a directory name of the asset directory 300 including the asset roll directory 310 stored in the second recording medium 80 on the basis of a path to the asset manifest file 314 stored in the index manifest file 340 retrieved by the second index retrieving unit 720. Here, the second asset directory detecting unit 725 may detect that the asset directory 300 does not exist in case the second recording medium 80 does not include the asset roll directory 300 and includes the asset roll directory 310 right under the root directory. The second asset directory detecting unit 725 outputs the detected directory name of the asset directory 300 to the asset directory making unit 730, the asset roll directory making unit 735, and the asset recording unit 740.

The asset directory making unit 730 makes the asset directory 300 of a predetermined name in the second recording medium 80 in case the directory names of the asset directory 300 detected by the first and second asset directory detecting units 705 and 725 are not the same. Then, the asset directory making unit 730 outputs a path to the made asset directory 300 to the asset roll directory making unit 735.

The asset roll directory making unit 735 makes the asset manifest file 314 retrieved by the asset manifest retrieving unit 710 and the asset roll directory 310 which should store the plurality of original images 312 retrieved by the image retrieving unit 715 in the second recording medium 80. Specifically, the asset roll directory making unit 735 makes the asset roll directory 310 in a lower level of the asset directory 300 of the second recording medium 80 in case the directory names of the asset directory 300 detected by the first and second asset directory detecting units 705 and 725 are the same. Further, the asset roll directory making unit 735 makes the asset roll directory 310 in a lower level of the asset directory 300 made by the asset directory making unit 730 of the second recording medium 80 in case the directory names of the asset directory 300 detected by the first and second asset directory detecting units 705 and 725 are not the same. In additions the asset roll directory making unit 735 may determine a directory name of the asset roll directory 310 to be made on the basis of the path to the asset manifest file 314 of the first recording medium 60 received from the first asset directory detecting unit 710 so that the asset manifest file 314 have the same directory name as that of the asset roll directory 310 stored in the first recording medium 60. Then, the asset roll directory making unit 735 outputs the path to the made asset roll directory 310 to the asset recording unit 740.

The asset recording unit 740 records the asset manifest file 314 recorded on the first recording medium 60 retrieved by the asset manifest retrieving unit 710 and the plurality of original image 312 recorded on the first recording medium 60 retrieved by the image retrieving unit 715 on the second recording medium 80 so as to be stored in the asset roll directory 310 made by the asset roll directory making unit 735. The asset recording unit 740 outputs the path to the recorded asset manifest file 314.

The index generating unit 745 generates a new index manifest file 340 by storing further the path to the asset manifest file 314 recorded by the asset recording unit 740 on the second recording medium 80 in the index manifest file 340 which is previously recorded on the second recording medium and retrieved by the second index retrieving unit 720. Then, the index generating unit 745 outputs the new index manifest file generated 340 to the index recording unit 750.

The index recording unit 750 renews the index manifest file 340 which is previously recorded on the second recording medium 80 by using the new index manifest file 340 generated by the index generating unit 745. For example, in case the second recording medium 80 is a write-once type, the index recording unit 750 may nullify the index manifest file 340 previously recorded and record the new index manifest file 340 on a region on which information is not recorded yet.

According to the image recording apparatus 70 of the present embodiment, it is possible to record the plurality of original images 312 recorded on the first recording medium 60, which is a recording medium other than the second recording medium 80, additionally on the second recording medium 80 on which the original image 312 is previously recorded. Further, according to the image recording apparatus 70, in case each recording medium is based on the same format, it is possible to record the plurality of original images 312 and the asset manifest file 314 of the first recording medium 60 without changing the path to the plurality of original images 312 and the asset manifest file 314 of the first recording medium 60. Further, according to the image recording apparatus 70, in case each recording medium is based on a different format from each other, it is possible to make the asset directory 300 of a predetermined directory name and record the plurality of original images 312 and the asset manifest file 314 on the second recording medium 80. Therefore, according to the recording apparatus 70, it is possible to copy the original image 312 from the first recording medium 60 to the second recording medium 80 and vice versa regardless of the format of the first and second recording mediums 60 and 80.

The image recording apparatus 70 shown in the present figure records the plurality of original images 312 and the asset manifest file 314 recorded on the first recording medium on the second recording medium 80. In addition, the image recording apparatus 70 may further record the album manifest file 332 recorded on the first recording medium 60 on the second recording medium 80. In this case, the recording apparatus 70 may renew the album manifest file 332 so that the path to the asset manifest file 314 and the displaying order of the plurality of original images 312 recorded by the asset recording unit 740 are further stored in the album manifest file 332 previously recorded on the second recording medium 80. Instead, the recording apparatus 70 may record a new album manifest file 332 storing the path to the asset manifest file 314 and the displaying order of the plurality of original images 312 recorded by the asset recording unit 740 independently from the album manifest file 332 previously recorded on the second recording medium 80.

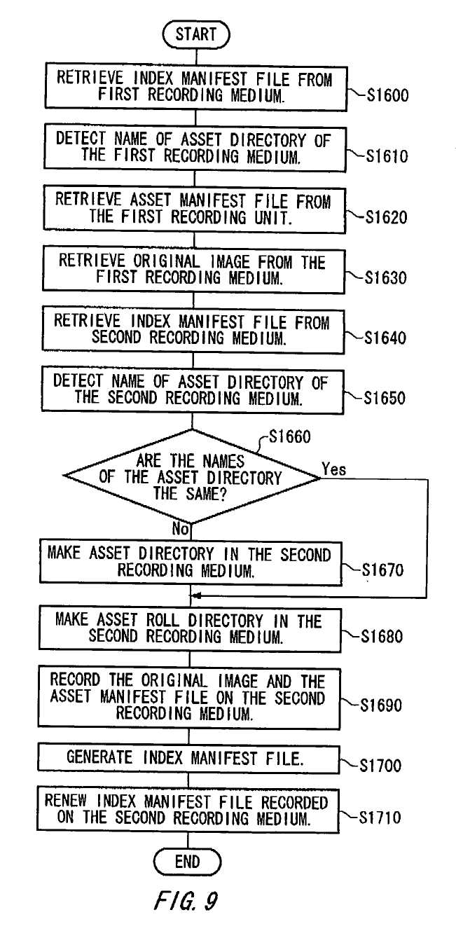

FIG. 9 is a flowchart showing an example of a flow of process by the image recording method using the image recording apparatus 70 according to the present embodiment. The first index retrieving unit 700 retrieves the index manifest file 340 from the first recording medium 60 (S1600). The first asset directory detecting unit 705 detects the directory name of the asset directory 300 including the asset roll directory 310 stored in the first recording medium 60 on the basis of the path to the asset manifest file 314 stored in the index manifest file 340 retrieved by the first index retrieving unit 700 (S1610). The asset manifest retrieving unit 710 retrieves the asset manifest file 314 from the first recording medium 60 by using the path to the asset manifest file 314 stored in the index manifest file 340 retrieved by the first index retrieving unit 700 (S1620). The image retrieving unit 715 retrieves the plurality of original images 312 form the first recording medium 60 by using the path to each of the plurality of original images 312 stored in the asset manifest file 314 retrieved by the asset manifest retrieving unit 710 (S1630).

The second index retrieving unit 720 retrieves the index manifest file 340 from the second recording medium 80 (S1640). The second asset directory detecting unit 725 detects the directory name of the asset directory 300 including the asset roll directory 310 stored in the second recording medium 80 on the basis of the path to the asset manifest file 314 stored in the index manifest file 340 retrieved by the second index retrieving unit 720 (S650).

Then, the image recording apparatus 70 determines whether or not the directory names of the asset directory 300 detected by the first and second asset directory detecting units 705 and 725 are the same (S1660). In case the directory names of the asset directory 300 are not the same (S1660: No), the asset directory making unit 730 makes the asset directory 300 of a predetermined name in the second recording medium 80 (S1670).

Then, the asset roll directory making unit 735 makes the asset manifest file 314 retrieved by the asset manifest retrieving unit 710 and the asset roll directory 310 which should store the plurality of original images 312 retrieved by the image retrieving unit 715 in the second recording medium 80 (S1680). The asset recording unit 740 records the asset manifest file 314 which is recorded on the first recording medium 60 and retrieved by the asset manifest retrieving unit 710 and the plurality of original images 312 which are recorded on the first recording medium 60 and retrieved by the image retrieving unit 715 on the second recording medium 80 so as to be stored in the asset roll directory 310 made by the asset roll directory making unit 735 (S1690).

The index generating unit 745 generates a new index manifest file 340 by storing further the path to the asset manifest file 314 which is retrieved from the first recording medium 60 by the asset manifest retrieving unit 710 and recorded on the second recording medium 80 by the asset recording unit 740 in the index manifest file 340 which is previously recorded on the second recording medium 80 and retrieved by the second index retrieving unit 720 (S1700). The index recording unit 750 renews the index manifest file 340 previously recorded on the second recording medium 80 by using the new index manifest file 340 generated by the index generating unit 745 (S1710).

Appendix A-1, A-2 and A-3 give another example of the present embodiment.

Although the present invention has been described by way of exemplary embodiments, it should be understood that those skilled in the art might make many changes and substitutions without departing from the spirit and the scope of the present invention which is defined only by the appended claims.

As clear from the above description, according to the present invention, it is possible to retrieve an original image recorded on a recording medium regardless of the format of the recording medium.

What is claimed is:

1. An image retrieving apparatus for retrieving a plurality of original images from a recording medium on which a plurality of original images taken are recorded, comprising:
an index retrieving unit for retrieving an index manifest file from the recording medium;
an asset manifest retrieving unit for retrieving an asset manifest file from the recording medium by using a path, stored in the retrieved index manifest file, to the asset manifest file; and
an image retrieving unit for retrieving at least a part of the plurality of original images from the recording medium by using a path, stored in the retrieved asset manifest file, to each of the plurality of original images,
wherein the recording medium comprises:
the plurality of original images;
the asset manifest file storing the path to each of the plurality of original images; and
the index manifest file storing the path to the asset manifest file, and
the index manifest file is stored on a predetermined path which is not different for each recording medium.

2. An image retrieving apparatus as claimed in claim 1 further comprising:
an image display unit for displaying a retrieved display image, wherein
the recording medium further comprises a plurality of display images generated by decreasing resolution of the plurality of original images,
the asset manifest file further stores a path to each of the plurality of display images, and
said image retrieving unit retrieves at least a part of the plurality of display images from the recording medium by using the path, stored in the retrieved asset manifest file, to each of the plurality of display images.

3. An image retrieving apparatus as claimed in claim 2 further comprising:
an album manifest retrieving unit for retrieving an album manifest file from the recording medium by using a path, stored in the retrieved index manifest file, to the album manifest file, wherein
the recording medium further comprises the album manifest file which determines a displaying order of at least a part of the plurality of the original images,
the index manifest file further stores the path to the album manifest file,
said image retrieving unit retrieves the display image in case the path to the display image generated from the original image is stored in the asset manifest file, or the original image in case the path to the display image generated from the original image is not stored in the asset manifest file, for each of the original images which should be displayed according to the displaying order determined by the retrieved album manifest file, and
said image display unit displays the display image or the original image.

4. An image retrieving method for retrieving a plurality of original images from a recording medium on which a plurality of original images taken are recorded, comprising:
an index retrieving step of retrieving an index manifest file from the recording medium;
an asset manifest retrieving step of retrieving an asset manifest file from the recording medium by using a path, stored in the retrieved index manifest file, to the asset manifest file; and
an image retrieving step of retrieving at least a part of the plurality of original images from the recording medium by using a path, stored in the retrieved asset manifest file, to each of the plurality of original images,
wherein the recording medium comprises:
the plurality of original images;
the asset manifest file storing the path to each of the plurality of original images; and
the index manifest file storing the path to the asset manifest file, and
the index manifest file is stored on a predetermined path which is not different for each recording medium.

5. An image retrieving method as claimed in claim 4 further comprising:
an image display step of displaying a retrieved display image, wherein
the recording medium further comprises a plurality of display images generated by decreasing resolution of the plurality of original images,
the asset manifest file further stores a path to each of the plurality of display images, and
during said image retrieving step, at least a part of the plurality of display images is retrieved from the recording medium by using the path, stored in the retrieved asset manifest file, to each of the plurality of display images.

6. An image retrieving method as claimed in claim 5 further comprising:
an album manifest retrieving step of retrieving an album manifest file from the recording medium by using a path, stored in the retrieved index manifest file, to the album manifest file, wherein
the recording medium further comprises the album manifest file which determines a displaying order of at least a part of the plurality of the original images,
the index manifest file further stores the path to the album manifest file,
during said image retrieving step, the display image is retrieved in case the path to the display image generated from the original image is stored in the asset manifest file, or the original image is retrieved in case the path to the display image generated from the original image is not stored in the asset manifest file, for each of the original images which should be displayed according to the displaying order determined by the retrieved album manifest file, and
during said image display step, the display image or the original image is displayed.

7. A recording medium on which a plurality of original images taken are recorded, comprising:
a plurality of original images;
an asset manifest file storing a path to each of said plurality of original images; and
an index manifest file storing a path to said asset manifest file, wherein
said index manifest file is stored on a predetermined path which is not different for each recording medium.

8. A recording medium as claimed in claim 7 further comprising:
a plurality of display images generated by decreasing resolution of said plurality of original images, wherein
said asset manifest file further stores a path to each of said plurality of display images.

9. A recording medium as claimed in claim 8 further comprising:
an album manifest file which determines a displaying order of at least a part of said plurality of original images, wherein said index manifest file further stores the path to said album manifest file.
